(19) United States
(12) Patent Application Publication
(10) Pub. No.: US 2011/0136067 A1
(43) Pub. Date: Jun. 9, 2011

(54) Fuel Insert

(76) Inventor: Thomas Grieb, Krefeld (DE)

(21) Appl. No.: 13/058,429

(22) PCT Filed: May 14, 2009
(86) PCT No.: PCT/EP2009/055827

§ 371 Date: Feb. 10, 2011

(30) Foreign Application Priority Data
Aug. 11, 2008 (EP) 08014308.4

(51) Int. Cl. F23D 14/24; B05B 7/10

(52) U.S. Cl. 431/182; 239/399

(57) ABSTRACT

A fuel nozzle for imparting swirl to a fuel/fuel-air mixture is provided. The fuel nozzle includes a holding unit and a nozzle insert, wherein the holding unit and the nozzle insert form a flow path and subsequently a swirl chamber, wherein the nozzle insert includes an inlet start and an inlet end. The inlet start and the inlet end are bent in a substantially circular manner such that an unbroken circle is formed, such that a fuel flowing into the swirl chamber has imparted to it a radially inwardly directed circular, in particular spiral movement. A burner and a gas turbine are also provided.

### CROSS REFERENCE TO RELATED APPLICATIONS

This application is the US National Stage of International Application No. PCT/EP2009/055827, filed May 14, 2009 and claims the benefit thereof. The International Application claims the benefits of European Patent Office application No. 09014308.4 EP filed Aug. 11, 2008. All of the applications are incorporated by reference herein in their entirety.

### FIELD OF INVENTION

The present invention relates to a fuel nozzle for imparting swirl to a fuel/fuel-air mixture. The invention further relates to a burner and a gas turbine.

### BACKGROUND OF INVENTION

Gas turbines are known to contain the following components: a compressor for compressing air; a combustion chamber for generating hot gas by burning fuel in the presence of compressed air delivered by the compressor; and a turbine, in which the hot gas delivered by the combustion chamber is expanded. Gas turbines are known to emit undesired nitrous oxide (NOx) and carbon monoxide (CO). A known factor influencing the NOx emissions is the combustion temperature. If the combustion temperature is reduced, the amount of NOx emitted falls. However high combustion temperatures are desirable in order to achieve high efficiency. It is known that leaner fuel/air mixtures burn cooler and therefore fewer NOx emissions are produced. A known technique for generating a leaner fuel mixture is to create turbulences in order to mix air and fuel before combustion as evenly as possible so as to avoid zones with rich mixture occurring in which there are local points with a higher temperature (so-called hotspots). With can, can annular and annular systems a flow of fuel is therefore introduced via a so-called swirler. In such cases compressed air is fed into the combustion chamber through a duct. Swirlers which are connected to a fuel line are arranged in this duct. These swirlers swirl the combustion air and simultaneously introduce fuel into the combustion air via holes in the swirler blades. This mixture then flows into the combustion chamber in order to be burned there. As homogenous a mixture of fuel to air as possible is achieved by this system, making a significant contribution to NOx reduction.

GB 760 972 A discloses a nozzle in which a rotation is imparted to the fluid to be injected in a circulation chamber arranged in the nozzle opening.

DE 20 15 470 A1 discloses a spray nozzle in which the pressure level of the flow medium to be sprayed is converted in a circulation chamber into kinetic rotation energy.

DE 22 32 686 A1 discloses a spray nozzle with a spiral swirl chamber arranged in the spray opening.

In combustion machines, especially those that are operated with two different fuels, the fuel oil is typically injected via swirl generators in which the oil is mixed with air. For better atomization and mixing of oil and air a swirling movement can be imparted to the oil within the nozzles used for injection. This imparting of a swirling movement within the oil nozzle has previously been achieved by these nozzles consisting of a number of small plates which have holes at coordinates deviating slightly from one another. By soldering together the individual plates a spiral is produced which is used for imparting the swirl to the fuel. However such nozzles have a complicated layout in construction terms since the holes must be placed exactly.

### SUMMARY OF INVENTION

A first object of the present invention is thus to provide a fuel nozzle which overcomes the above-mentioned difficulties. A second object of the present invention is to disclose an advantageous burner. A third object of the invention is to provide an advantageous gas turbine.

The first object is achieved by a fuel nozzle in accordance with the claims. The second object is achieved by a burner as claimed in the claims. The object relating to the gas turbine is achieved by a gas turbine in accordance with the claims. The independent claims contain further advantageous developments of the invention.

Inventively it is therefore proposed here to arrange a component, namely the fuel insert, in another component, namely the holding unit. A flow path and a swirl chamber are embodied by said components. This means that a simpler installation of the inventive “nozzle” is possible. Thus fuel, especially liquid fuel, flows through the flow path.

The flow path can itself assume a type of nozzle function in such cases by being differently geometrically shaped, e.g. narrowing or widening out at the flow inlet into the swirl chamber. If the fuel is accelerated in the flow path, meaning that the greatest speed is only on entry into the holding unit itself, pressure losses and cavitations that are too high can be avoided. At the inlet start of the fuel as well as at the end, meaning essentially in the swirl chamber itself, the nozzle insert is bent in a substantially circular manner and thus substantially fauns an interrupted circle. Flow thus leaves a flow path here and enters a swirl chamber and does so such that the fuel executes a circular, especially a spiral-shaped movement in the swirl chamber. The inventive nozzle insert thus creates a swirl component in the swirl chamber, especially in the combustion chamber downstream as well. In this case a depth of the holding unit reduces at the inlet start of the nozzle insert in the flow direction. The effect of this is that the flow speed of the fuel changes, namely increases.

The flow path, which is formed by the inlet start of the nozzle insert and the holding unit, can also narrow in the direction of flow. This likewise brings about an increase in the flow speed. As an alternative the flow path, which is formed by the inlet start of the nozzle insert and the holding unit, can also widen out in the flow direction. This likewise brings about an increase in the flow speed. With a simultaneous reduction of the depth of the holding unit at the inlet start in the flow direction the flow speed can also be increased in this way.

Preferably the nozzle insert is able to be inserted as an integrated component in the holding unit. The swirl chamber is preferably embodied in a circular shape. Thus the fuel inlet with its inlet start and end bent into the shape of a semicircle can be integrated into the holding unit in an especially stable manner. However other geometrical shapes are also conceivable. The swirl chamber can also include an outlet so that the fuel can exit swirled at this point. The outlet thus serves as an atomizer nozzle and can for example likewise have a tapering shape. The fuel swirled in this manner then enters the combustion chamber. Preferably the outlet is a hole, especially a transverse hole. This is especially easy to make, even retrospectively. In a preferred development four—eight fuel nozzles arranged symmetrically on a disk are included as the fuel nozzle arrangement. This disk is accordingly integrated into an adapted holding unit of the attachment. The attachment in this case likewise essentially includes four—eight outlets. Thus a fuel nozzle arrangement is inventively created which is integrated into an attachment and which thus includes all outlets (spray nozzles). Thus the fuel is divided up into individual flows on its circumference. The number of nozzle inserts and holding units arranged on the disk can vary in this case, as can the arrangement of the nozzle inserts/holding units on the disk.

Preferably the nozzle insert and/or the holding unit consists of metal or a metal alloy. In a preferred development the nozzle insert and/or the holding unit consists of ceramic or a ceramic material since these materials are especially resistant to wear.

Preferably the nozzle insert and/or the holding unit are able to be manufactured using precision mechanics or print techniques. This manufacturing is especially fast and cost effective to implement.

### BRIEF DESCRIPTION OF THE DRAWINGS

Further advantages, features and characteristics of the present invention are explained below in greater detail on the basis of exemplary embodiments which refer to the enclosed figures. The features of the exemplary embodiments can be of advantage individually or in combination with each other in these embodiments.

FIG. 1 shows a schematic diagram of a section along the length of a gas turbine,

FIG. 2 shows a schematic diagram of a section through a burner with a nozzle according to the prior art,

FIG. 3 shows a schematic diagram of an inventive burner insert,

FIGS. 4, 5 show schematic diagrams of an attachment 13 with 4 inventive burner inserts, viewed from the rear and the front.

### DETAILED DESCRIPTION OF INVENTION

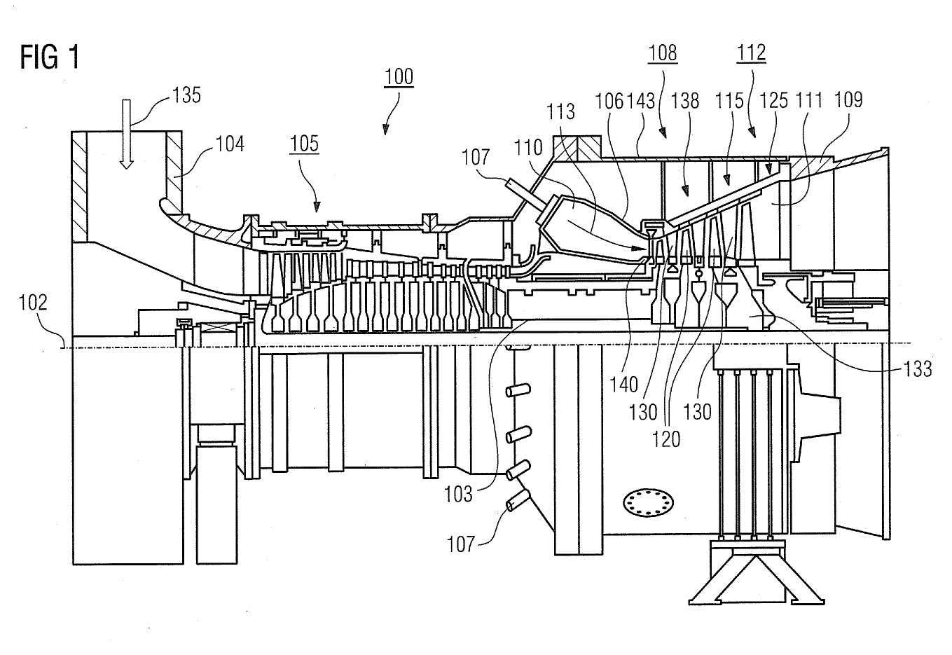

A first exemplary embodiment of the present invention is explained below in greater detail with reference to FIGS. 1 through 5.

FIG. 1 shows an example of a section along the length of a gas turbine 100.

The gas turbine 100 has a rotor 103 inside it supported to allow its rotation around an axis of rotation 102 with a shaft, which is also referred to as the turbine rotor.

Following each other along the rotor 103 are an induction housing 104, a compressor 105, a typically toroidal combustion chamber 110 with a number of coaxially arranged burners 107, a turbine 108 and the exhaust housing 109.

The combustion chamber 110 communicates with a typically annular hot gas duct 111. In this duct four turbine stages 112 connected one behind the other form the turbine 108 for example.

Each turbine stage 112 is typically formed from two rings of blades. In the hot gas duct 111, seen in the flow direction of a working medium 113, a series of guide blades 115 is followed by a series 125 composed of rotor blades 120.

The guide blades 130 are attached in this case to an inner housing 138 of a stator 143, whereas the rotor blades 120 of a series 125 are attached for example by means of a turbine disk 133 to the rotor 103.

Coupled to the rotor 103 is a generator or work machine (not shown).

During the operation of the gas turbine 100, air 135 is sucked by the compressor 105 through the induction housing 104 and compressed. The compressed air provided at the turbine-side end of the compressor 105 is directed to the burners 107 and mixed there with a fuel. The mixture is burned to form a working medium 113 in the combustion chamber 110. From there the working medium 113 flows along the hot gas duct 111 past the guide blades 130 and the rotor blades 120. At the rotor blades 120 the working medium 113 expands and imparts a pulse so that the rotor blades 120 drive the rotor 103 and this drives the working machine coupled to it.

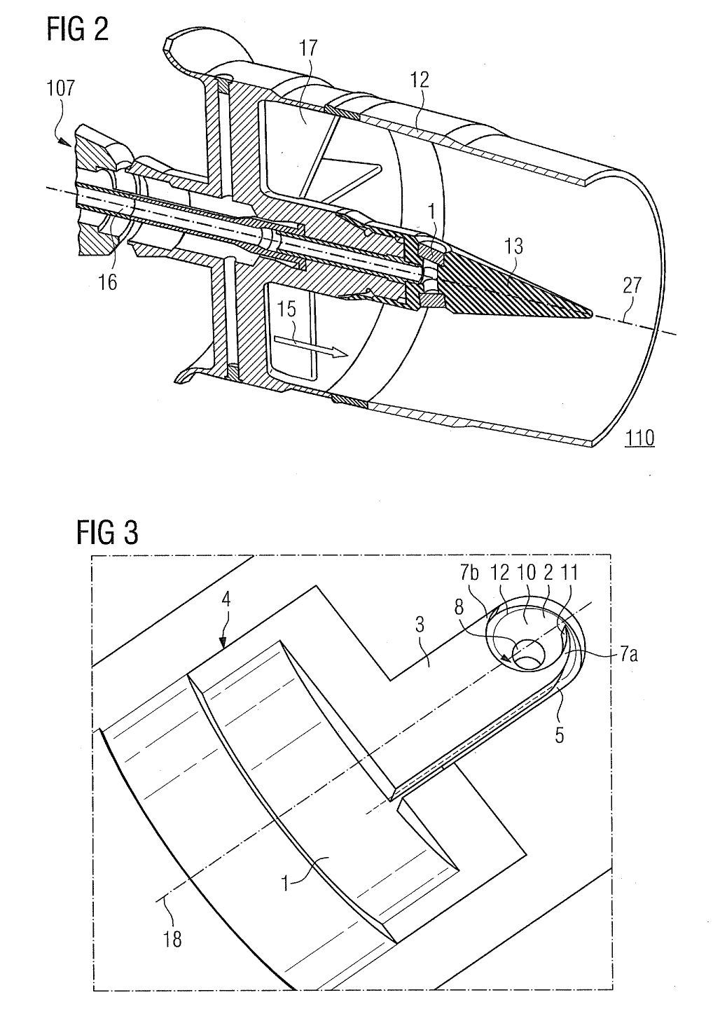

FIG. 2 shows a schematic diagram of a section through a burner 107 with a nozzle according to the prior art in a part perspective view. The burner 107 can be used on the one hand in conjunction with the annular combustion chamber 106. Preferably the burner 107 is however used in conjunction with what is referred to as a tubular combustion chamber. In this case the gas turbine 100, instead of the annular combustion chamber 106, has a number of tubular combustion chambers arranged in a ring, of which the downstream-side openings open out into the annular hot gas duct 111 on the turbine inlet side. In such cases a number of burners 107, for example six or eight, are preferably arranged on the opposite end of the downstream-side opening of the tubular combustion chamber, mostly in the form of a ring around a pilot burner.

The burner 107 comprises a cylindrical housing 12. In the housing 12 a lance with a fuel duct 16 is arranged along the central axis 27 of the burner 107. On the side of the lance leading into the combustion chamber 110 this has an attachment 13 coming to a point, which is arranged concentrically to the center axis 27. Arranged in the attachment 13 are the prior-art fuel nozzles 1, which communicate with the fuel duct 16.

Swirl blades 17 are arranged in the housing 12 of the inventive burner 107 around the lance. The swirl blades 17 are arranged along the circumference of the lance in the housing 12. A compressor airflow 15 is conveyed by the swirl blades 17 into the part of the burner 107 leading to the combustion chamber 110. A swirling motion is imparted to the air by the swirl blades 17. Fuel, for example oil, is injected through the fuel nozzles 1 into the air flow produced by this process. The fuel-air mixture arising as a result of this is then conveyed further in the combustion chamber 110.

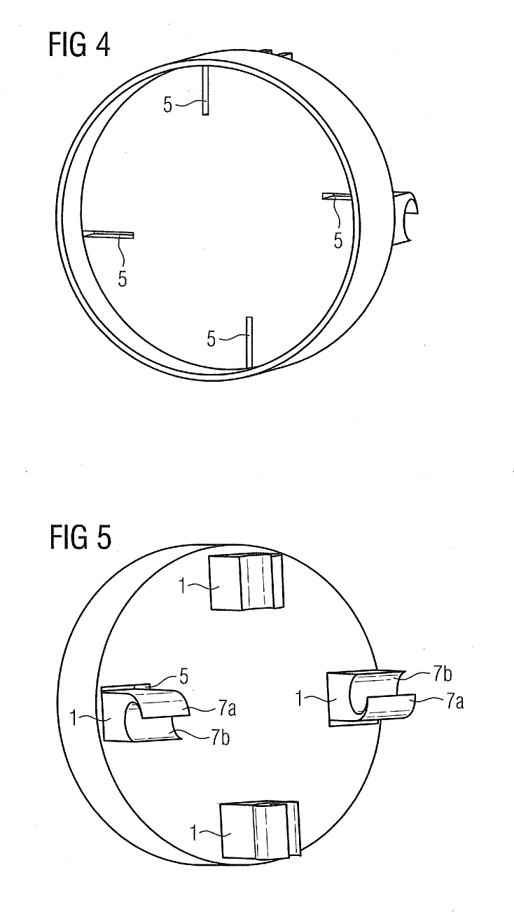

FIG. 3 shows a schematic diagram of a section through an inventive fuel nozzle. The nozzle inserts 1 are arranged on the outer circumference of the attachment 13 in corresponding holding units 4. A fuel nozzle arrangement comprises a number, four in the present exemplary embodiment, of inventive nozzle inserts 1 with corresponding holding units 4 (FIG. 4, rear view and FIG. 5, front view). The flow paths 5 are indicated in the figures (FIG. 4, FIG. 5) as four slots.

The center axis of the attachment 13 is labeled with the reference number 18. The attachment 13 is embodied conical towards the combustion chamber 110, running to a point. The nozzle insert 1 is arranged on the outer circumference of the attachment 13 in the corresponding holding units 4 and thus forms the swirl chambers 10. The inventive nozzle insert 1 is manufactured as an integrated component. At its fuel inlet 2, which is located in the swirl chamber 10, the inventive nozzle insert 1 includes an inlet start 7a and also an inlet end 7b which are bent in a substantially circular manner. The nozzle insert 1 features a nozzle insert collar 3. The nozzle insert 1, especially the nozzle insert collar 3 itself, as well as the inlet start 7a preferably bent in a circular manner, along with the holding unit 4, form a flow path 5, along which the fuel can flow. Along with the holding unit 4, the inlet start 7a and the end 7b embody the swirl chamber 10. In this case the flow path 5, which is formed by the inlet start 7a of the nozzle insert 1 and the holding unit 4, can narrow or also widen in the direction of flow. With a widening out of the flow path 5, the inlet start 7a bent in a semicircular manner is essentially bent towards an outlet 8. The fuel which flows through the flow path 5 is then deflected towards the center. With a narrowing the inlet start 7a is bent away from the outlet and thus narrows the flow path 5. The flow speed is increased. The speed can also be increased by the depth of the holding unit 4 changing, preferably reducing at the inlet start 7a in the flow direction. In such cases a linear reduction or also a non-linear reduction is possible. The swirl chamber 10 is embodied substantially in the shape of a circle. This arrangement thus causes the flow path 5 to execute a circular movement at the inlet start 7a in the swirl chamber 10, which steers the fuel in the direction of outlet 8. The fuel thus executes a circular movement, meaning that the fuel is thus swirled in a circular, especially spiral 12 manner. Subsequently the fuel swirled in this way exits from the outlet 8 for the purposes of atomization. In this case the outlet 8 is a transverse hole for the purposes of outflow.

The inventive nozzle insert 1 thus creates a fuel flow, especially a liquid fuel flow with a swirl component in the chambers downstream.

A fuel nozzle is thus created with the inventive solution by a nozzle insert 1 able to be integrated into a holding unit 4. In particular a disk with an inventive fuel nozzle arrangement is created which is inserted into an attachment 13 or another component and thus supplies all outlets 8 (atomization openings) of the attachment 13. The fuel nozzle or the fuel nozzle arrangement divides the fuel flow into individual flows distributed on the circumference. The previously used nozzles serve to impart a swirling movement in the flow of fuel before this reaches the combustion chambers. The swirl is now created by means of the specific geometry of the inventive fuel nozzle. The fuel nozzle or the holding unit and/or the nozzle insert can be manufactured from metallic also ceramic materials using precision mechanics or “print”-based techniques.

Optionally an acceleration of the fuel can take place in the flow path 5 in order in this way to achieve the greatest speed only on entry into the swirl chamber 10, so that pressure losses that are too high and cavitation are avoided and in this way an effective nozzle cross-section is obtained which is more independent of the throughput. This can be achieved for example by the inlet start 7a being bent towards the outlet center 8 or bent away from the outlet center 8 and/or by the depth of the holding unit 4 changing at the inlet start 7a.

1.-15. (canceled)

16. A fuel nozzle for swirling a fuel/fuel-air mixture, comprising:
a holding unit; and
a nozzle insert;
a flow path; and
a swirl chamber,
wherein the nozzle insert and the holding unit embody the flow path and subsequently the swirl chamber,
wherein the nozzle insert includes an inlet start and an inlet end,
wherein the inlet start and the inlet end are bent in a substantially circular manner so that an interrupted circle is formed, and that a fuel flowing into the swirl chamber has a radially-inwards circular movement, and
wherein a depth of the holding unit reduces at the inlet start of the nozzle insert in a flow direction, so that a change in a flow speed of the fuel is brought about.

17. The fuel nozzle as claimed in claim 16, wherein the flow path which is formed by the inlet start of the nozzle insert and the holding unit, narrows in the flow direction.

18. The fuel nozzle as claimed in claim 16, wherein the flow path which is formed by the inlet start of the nozzle insert and the holding unit, widens in the flow direction.

19. The fuel nozzle as claimed in claim 16, wherein the nozzle insert is inserted as an integrated component into the holding unit.

20. The fuel nozzle as claimed in claim 16, wherein the holding unit and/or the nozzle insert comprises metal or a metal alloy.

21. The fuel nozzle as claimed in claim 16, wherein the holding unit and/or the nozzle insert comprises ceramics or ceramic material.

22. The fuel nozzle as claimed in claim 16, wherein the holding unit and/or the nozzle insert is manufactured using precision engineering or with print technology.

23. The fuel nozzle as claimed in claim 16, wherein the swirl chamber has a circular shape.

24. The fuel nozzle as claimed in claim 16, wherein that the swirl chamber comprises an outlet so that the fuel/fuel-air mixture exits swirled at the outlet.

25. The fuel nozzle as claimed in claim 24, wherein the outlet is a hole.

26. A fuel nozzle arrangement, comprising:
four to eight fuel nozzles arranged symmetrically on a disk, each fuel nozzle comprising:
a holding unit, and
a nozzle insert,
a flow path, and
a swirl chamber,
wherein the nozzle insert and the holding unit embody the flow path and the swirl chamber,
wherein the nozzle insert includes an inlet start and an inlet end,
wherein the inlet start and the inlet end are bent in a substantially circular manner so that an interrupted circle is formed, so that a fuel flowing into the swirl chamber has a radially-inwards circular movement, and
wherein that a depth of the holding unit reduces at the inlet start of the nozzle insert in a flow direction, so that a change in a flow speed of the fuel is brought about.

29. A burner, comprising:
a fuel nozzle arrangement, comprising:
four to eight fuel nozzles arranged symmetrically on a disk, each fuel nozzle comprising:
a holding unit, and
a nozzle insert,
a flow path, and
a swirl chamber,
wherein the nozzle insert and the holding unit embody the flow path and the swirl chamber,
wherein the nozzle insert includes an inlet start and an inlet end,
wherein the inlet start and the inlet end are bent in a substantially circular manner so that an interrupted circle is formed, so that a fuel flowing into the swirl chamber has a radially-inwards circular movement, and
wherein that a depth of the holding unit reduces at the inlet start of the nozzle insert in a flow direction, so that a change in a flow speed of the fuel is brought about.

34. The burner as claimed in claim 27, further comprising a cylindrical housing with a lance including a fuel duct arranged centrally therein, which is supported on the housing via a plurality of swirl blades in a radial arrangement and on which an attachment is arranged on a side leading into a combustion chamber, with the fuel nozzle arrangement being arranged in the attachment preferably downstream from the plurality of swirl blades and being flow-connected to the fuel duct.

27. A burner arrangement, comprising:
a plurality of burners, each burner comprising:
a fuel nozzle arrangement, comprising:
four to eight fuel nozzles arranged symmetrically on a disk, each fuel nozzle comprising:
a holding unit, and
a nozzle insert,
a flow path, and
a swirl chamber,
wherein the nozzle insert and the holding unit embody the flow path and the swirl chamber,
wherein the nozzle insert includes an inlet start and an inlet end,
wherein the inlet start and the inlet end are bent in a substantially circular manner so that an interrupted circle is formed, so that a fuel flowing into the swirl chamber has a radially-inwards circular movement,
wherein that a depth of the holding unit reduces at the inlet start of the nozzle insert in a flow direction, so that a change in a flow speed of the fuel is brought about, and
wherein the plurality of burners are arranged in a form of a ring around a central pilot burner.

35. A gas turbine, comprising:
a burner, comprising:
a fuel nozzle arrangement, comprising:
four to eight fuel nozzles arranged symmetrically on a disk, each fuel nozzle comprising:
a holding unit, and
a nozzle insert,
a flow path, and
a swirl chamber,
wherein the nozzle insert and the holding unit embody the flow path and the swirl chamber,
wherein the nozzle insert includes an inlet start and an inlet end,
wherein the inlet start and the inlet end are bent in a substantially circular manner so that an interrupted circle is formed, so that a fuel flowing into the swirl chamber has a radially-inwards circular movement, and
wherein that a depth of the holding unit reduces at the inlet start of the nozzle insert in a flow direction, so that a change in a flow speed of the fuel is brought about.
